(19) United States
(12) Patent Application Publication
(10) Pub. No.: US 2019/0392540 A1
(43) Pub. Date: Dec. 26, 2019

(54) SCHOOL AND PARENT COMMUNICATION SYSTEM AND METHOD OF USE

(71) Applicant: B A. Myahwegi, Philidelphia, PA (US)

(72) Inventor: B A. Myahwegi, Philidelphia, PA (US)

(21) Appl. No.: 16/283,676

(22) Filed: Feb. 22, 2019

Related U.S. Application Data
(60) Provisional application No. 62/633,695, filed on Feb. 22, 2018.

(51) Int. Cl. G06Q 50/26; H04W 4/029; H04W 68/02

(52) U.S. Cl. CPC G06Q 50/26; H04W 68/02; H04W 4/029

(57) ABSTRACT

A communication system for initiating notifications between parents, school personnel, and school bus drivers, the communication system includes a network having a server to receive and transmit data; a first electronic device having a first identifier assigned to a school bus; a second electronic device having a second identifier assigned to a parent; a third electronic device associated with a school; and a communication platform being accessible by the first, second, and third electronic devices to facilitate communication between the first, second, and third electronic devices; the communication platform is to receive information from one of the first, second, and third electronic devices and transmit the information to other of the first, second, and third electronic devices.

### BACKGROUND

### 1. Field of the Invention

The present invention relates generally to communication systems, and more specifically, to an interactive communication system between parents, schools, caretakers, and multiple parties that require unsupervised/unverified transition of minors from one form of oversight to another by eliminating blind spots in real time.

### 2. Description of Related Art

Communication systems are well known in the art and are effective means for parents and schools to exchange information. Conventional communication systems between schools and parents involve the use of phones and computers to make phone calls and send emails between the two parties. For example, parents will receive newsletters and emails with updates regarding school closures, homework, school activities, and the like.

One of the problems commonly associated with conventional communication systems is the slow exchange of information. For example, mornings are particularly hectic for schools and families, therefore when an event occurs such as a child becoming sick, a car breaking down, or any other event, it is challenging for all necessary parties to be immediately notified.

Another common problem associated with school communication systems is the arrival of students to a bus pick up location at the correct time. For example, based on traffic, weather, and road conditions, a bus may be early or late from their standard arrival, thereby either forcing students to rush or wait in the elements.

There is further a need to manage “blind spots” between supervisors and minors when they are out of communication range. For example, parents desire to have a village effect (i.e. multiple points of oversight) to help watch after minors when such oversight isn't physically possible or practical. In addition, parents want to be alerted when their child needs them and/or when there is a health concern for their child.

The system of the present invention is configured to overcome all of the above shortcomings of the prior art, and further provides for verification of location of children, the collection of information for the sake of dispute resolution and verification, and collection of information for law enforcement and first responders.

Accordingly, although great strides have been made in the area of communication systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a communication system in accordance with a preferred embodiment of the present application;

FIG. 2 is a simplified schematic of a first use of the system of FIG. 1;

FIG. 3 is a flowchart of the method of first use of FIG. 2;

FIG. 4 is a simplified schematic of a second use of the system of FIG. 1;

FIG. 5 is a flowchart of the method of second use of FIG. 4;

FIG. 6 is a simplified schematic of a third use of the system of FIG. 1;

FIG. 7 is a flowchart of the method of third use of FIG. 6;

FIG. 8 is a simplified schematic of an alternative embodiment of a communication system of the present invention;

FIG. 9 is a flowchart of the method of use of FIG. 8; and

FIG. 10 is a schematic of a child wearable sensor in accordance with the present application for use with the various embodiments of the present application.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional communication systems. Specifically, the present invention provides an improved communication system for facilitating effective and efficient information between parents, schools, school bus drivers, and governmental agencies. The system of the present invention amalgamates cross functioning of wearable sensors, servers, mobile apps, Al and geointeractive capability in executing its functions. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

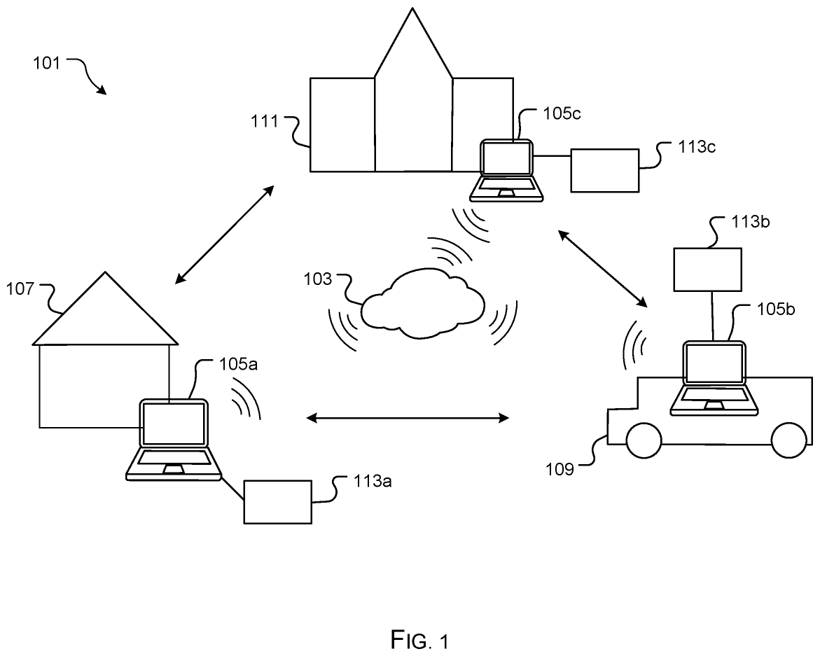

Referring now to the drawings wherein like reference characters identify corresponding or similar elements throughout the several views, FIG. 1 depicts a simplified schematic of a communication system 101 in accordance with a preferred embodiment of the present application. It will be appreciated that system 101 overcomes one or more of the above-listed problems commonly associated with conventional communication systems.

The system of the present invention can be utilized in connection with other systems to provide for improved safety and security of children/minors. The system can be utilized with amber alerts, to provide security for minors, to provide confirmation/verification of special needs minors in transition, to provide after disaster beacon for first responder locators, to provide group of friends in crowd locator, and to provide missing/lost animal interactive beacons.

In the contemplated embodiment, system 101 includes a network 103 having one or more of a server, database, and processor, thereby being configured to receive and process data. System 101 further includes a plurality of electronic devices 105a-c, the electronic devices being associated with households 107 (parents), school busses 109 (school bus drivers), schools 111.

It should be appreciated that the electronic devices 105a-c can be computing devices such as smart phone, tablets, computers, internet of things (IoT, cloud computing, Al applications, and hands free speakers, and other devices configured to be incorporated into vehicles or other control systems associated with households and schools. Further, it should be understood that many devices are contemplated for use with system 101, making the system configured to provide communication between many parties. Each electronic device is assigned a unique identifier, associated with the appropriate party.

In the preferred embodiment, each electronic device 105a-c is connected to a communication platform 113a-c, wherein communication platform 113a-c is configured to receive and transmit information from the parties through network 103.

It should be appreciated that one of the unique features believed characteristic of the present application is the communication platform configured to specifically transmit information between the parties, thereby ensuring that relevant information is transmitted timely. For example, a school can input information regarding school closures to be transmitted to parents and/or school bus drivers.

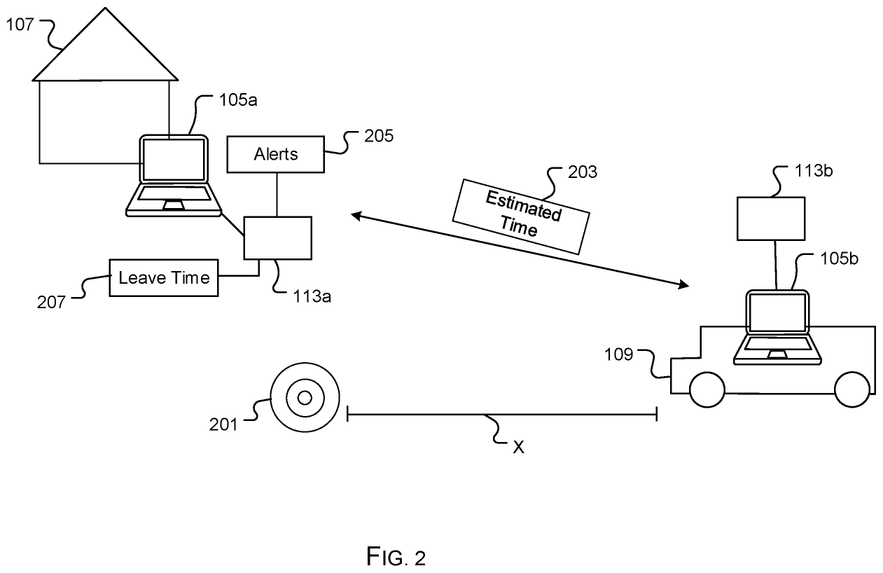

In FIG. 2, a simplified schematic demonstrates a first use and functionality of the communication platform 113a-c. In this embodiment, a bus pick up location 201 is predetermined and programmed into communication platform 113a-c. The electronic device 105b includes a geospatial tracking system, wherein a location of bus 109 can be determined in real time. Platform 113a-c and network 103 thereby determine a precise distance X from bus 109 to pick up location 201. Based on the distance X, an estimated time of arrival 203 is determined and transmitted to electronic device 105 to provide the household 107 with an alert 205. In some embodiments, it should be appreciated that constant alerts are transmitted based on the bus getting closer and closer to bus pick up location. Further, the electronic device 105a can have a geospatial tracking system incorporated therein, thereby allowing for communication platform 113a to further provide the household with a “leave time” 207, based on an estimated time for a student to walk to the pickup location 201.

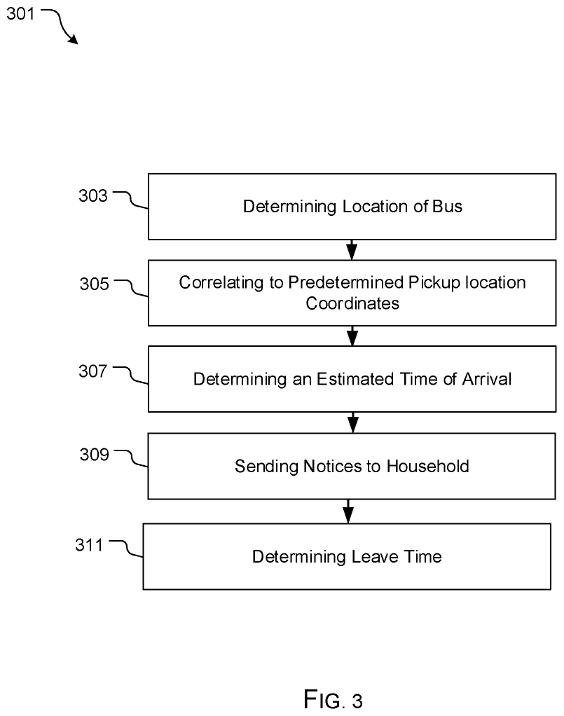

In FIG. 3, a flowchart 301 further depicts the method discussed in connection with FIG. 2. During use, a location of the bus is determined and correlated to the predetermined pickup location, as shown with boxes 303, 305. Based on this information, an estimated time of arrival is provided to the household, as shown in boxes 307, 309. In some embodiments, based on a determined location of the household, the communication platform provides a leave time for accurate arrival to the predetermined pickup location, as shown with box 311.

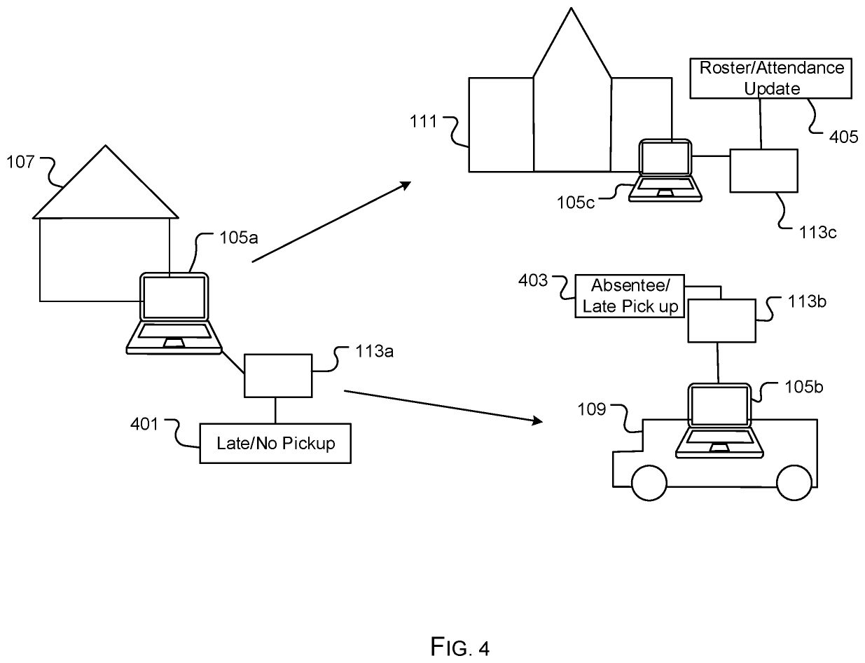

In FIG. 4, another simplified schematic demonstrates a second use of system 101, specifically for the exchange of information between parties. As shown, in the event that something happens regarding household 107, a parent, guardian, student, or anyone with permission can input information 401 into communication platform 113, this information can be regarding a student being late to school, being absent from school, taking an alternative source of transportation, or the like. This signals transmittal of alerts 403, 405 to the school 111 and necessary bus 109. This allows the school to update their roster, note an absence, or any other necessary record. In addition, this allows a bus driver to know if a student will not be taking the bus or will be late for pickup.

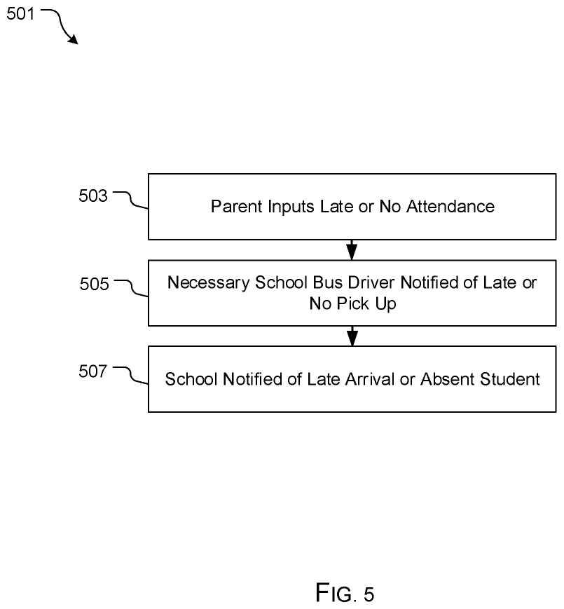

In FIG. 5, a flowchart 501 depicts a method associated with FIG. 4 above. During use, a parent or other use associated with the household inputs information such as a student running late or being absent, as shown with box 503. The information is then transferred to the school and appropriate bus for notifications, as shown with boxes 505, 507.

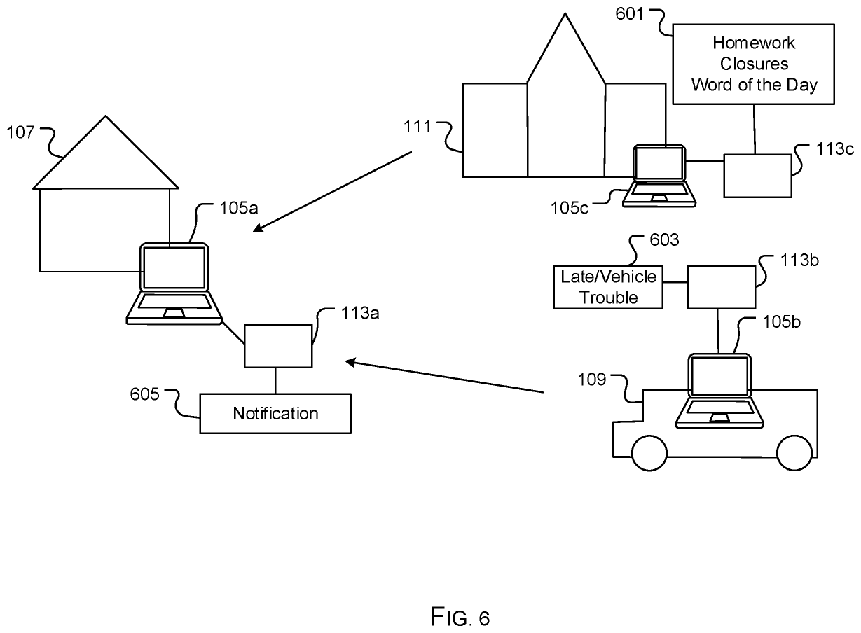

In FIG. 6, another simplified schematic demonstrates a third use associated with system 101. As shown, the school 111 and/or school bus 109 driver can provide information 601, 603, wherein notifications 605 are presented to the household. In this use, the school 111 can provide updates on homework, school closures, school activities, and/or word of the days to be transmitted to the household. Further, the school bus driver can provide updates on arrival times, delays, vehicle trouble, and the like.

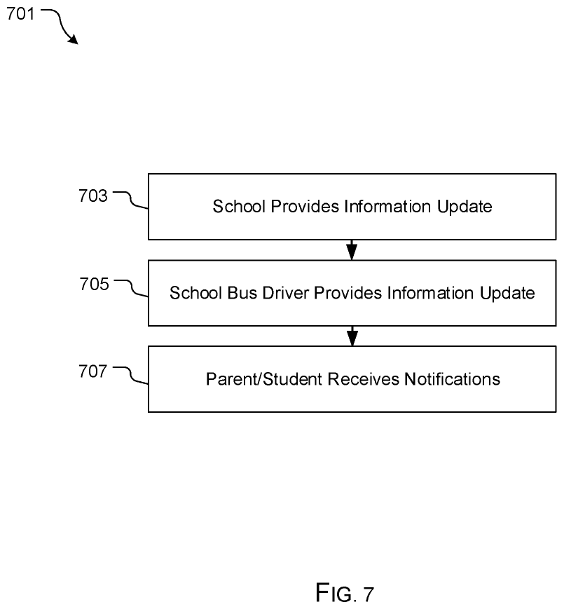

In FIG. 7, a flowchart 701 depicts a method of use associated with FIG. 6. School staff, such as teachers and principals, can provide updates, as shown with box 703. In addition, school bus drivers can provide updates to be transmitted to other parties, as shown with box 705. The household can then receive updates for the appropriate bus and school, as shown with box 707.

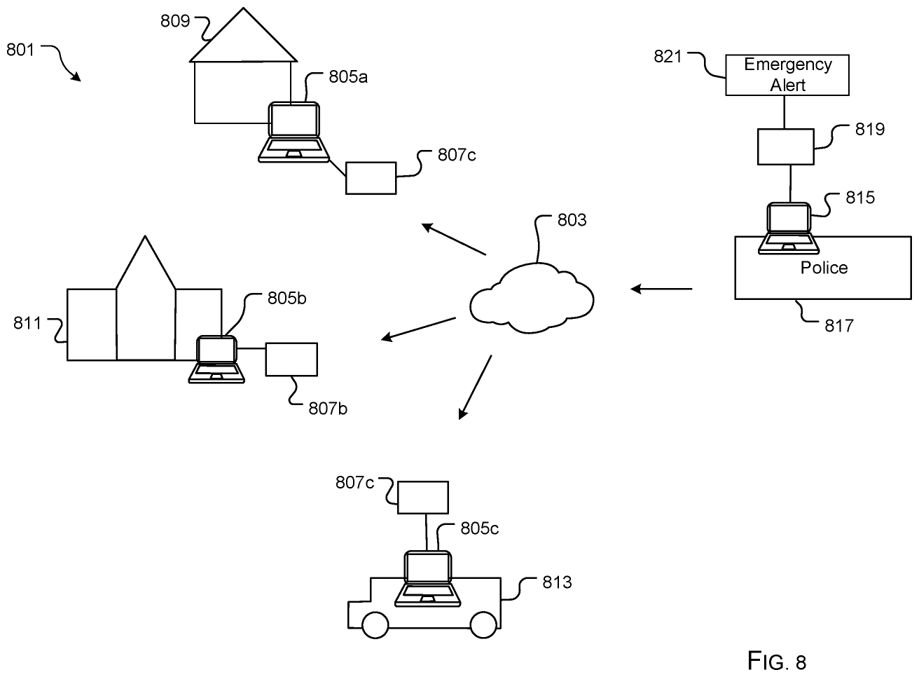

In FIG. 8, a simplified schematic demonstrates an alternative embodiment of a communication system 801 in accordance with the present application. System 801 includes all of the features discussed above and associated with system 101, including a network 803 configured to coordinate communication between a plurality of electronic devices 805a-c having communication platforms 807a-c and being associated with one or more households 809, one or more schools 811, and one or more school busses 813. System 801 further includes one or more electronic devices 815 associated with a governmental body 817, such as a police station. In this embodiment, the governmental body 817 can use communication platform 819 to provide alerts 821, such as amber alerts, dangerous people alerts, and the like. This embodiment provides a means for schools, school bus drivers, and households to receive notifications regarding potentially dangerous conditions and other emergencies.

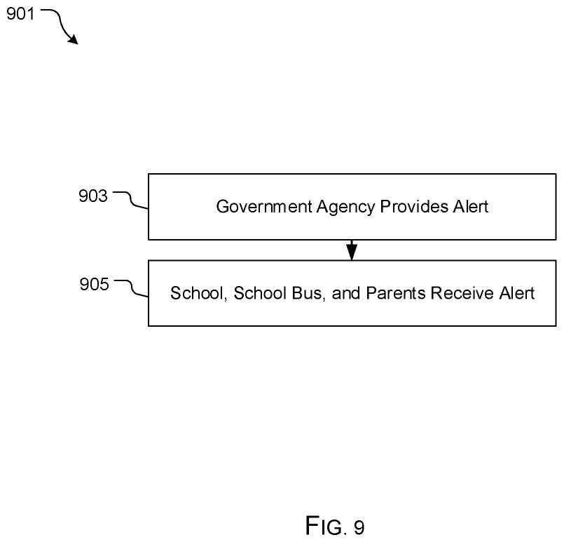

In FIG. 9, a flowchart 901 depicts a method of use of system 801. During use, the governmental agency provides alerts via the communication platform, wherein notifications are transmitted to schools, school buses, and/or households, as shown with boxes 903, 905.

It should be appreciated that all of the features discussed above with system 101 are further available with system 801. Further, all features of each system and embodiment discussed, can be interchanged.

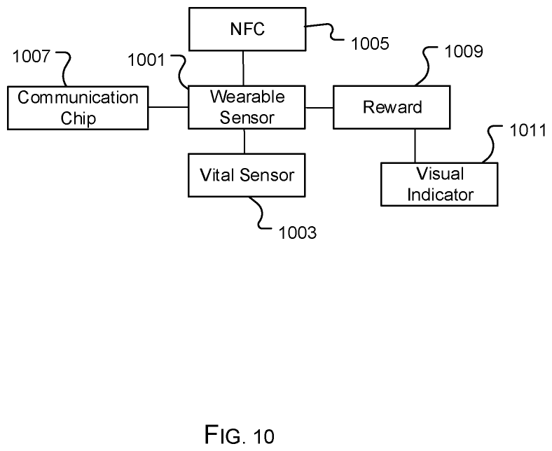

In FIG. 10, features of a wearable sensor 1001 are shown. It should be appreciated that each system and embodiment discussed above can include a wearable sensor 1001 for a child, wherein the wearable sensor 1001 can be one of a keychain, wristband, button, etc., and can include vital sensors 1003, such as moisture, temperature, and chemical sensors. The wearable sensor can include features such as an NFC chip 1005 that allows for passively checking into predesignated locations, such as being set by a parent or guardian. The sensor can further include a communication chip 1007 that allows for parents to be notified of the child's location. In addition, it is contemplated that the wearable 1001 can include a reward system 1009 that provides a means for parents and children to establish rewards, wherein the wearable will include a visual indication 1011. It is contemplated that one visual indication will be a series of lights that display how close the child is to the goal. The wearable can be used by parents and guardians to establish geofencing locations to define boundaries, such as where a child is allowed to go. Further, the parent can receive notifications of the child entering a specific location, such as a designated safe zone or a day care center, or the like.

The utilization of child wearables with any of the systems discussed above provide for improved child monitoring and safety.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A communication system for initiating notifications between parents, school personnel, and school bus drivers, the communication system comprising:
a network having a server configured to receive and transmit data;
a first electronic device having a first identifier assigned to a school bus;
a second electronic device having a second identifier assigned to a parent;
a third electronic device associated with a school; and
a communication platform being accessible by the first, second, and third electronic devices and configured to facilitate communication between the first, second, and third electronic devices;
wherein the communication platform is configured to receive information from one of the first, second, and third electronic devices and transmit the information to other of the first, second, and third electronic devices.

2. The system of claim 1, wherein the first electronic device comprises a first geospatial location mechanism configured to determine a first location associated with the school bus;
wherein the second electronic device comprises a second geospatial location mechanism configured to determine a second location associated with the parent; and
wherein the communication platform correlates the first location to the second location to provide proximity information to the parent and a school bus driver.

3. The system of claim 2, wherein the communication platform is further configured to provide a notification to the second device, the notification alerting the parent of an estimated time of arrival to a designated pick up location by the school bus.

4. The system of claim 1, wherein the third electronic device comprises:
an update input portal configured to receive an update from school personnel;
wherein the communication platform is configured to transmit the update to the first electronic device and second electronic device.

5. The system of claim 1, further comprising:
a fourth electronic device associated with a governmental authority;
wherein the communication platform is accessible via the fourth electronic device and configured to receive information from the governmental authority and transmit the information to the first, second, and third electronic devices.

6. A method of initiating communication between a school, one or more school bus drivers, and one or more parents, the method comprising:
providing a communication platform configured to be accessed via a plurality of electronic devices;
receiving information via the communication platform from one of the school, the one or more school bus drivers, and the one or more parents;
transmitting the information to each of the plurality of electronic devices; and
providing an alert on each of the plurality of electronic devices relating to the information.

7. The method of claim 6, further comprising:
determining locations associated with each of the one or more school bus drivers and the one or more parents;
correlating the locations to determine estimated arrival times at predetermined locations by the one or more school bus drivers; and
providing alerts to the one or more parents regarding the estimated arrival times.

8. The method of claim 6, further comprising:
receiving a notification of a delay from one of the one or more parents; and
alerting the school of the delay.

9. The method of claim 6, further comprising:
receiving a notification from a governmental agency through the communication platform; and
transmitting the notification to the plurality of electronic devices.

10. The method of claim 6, further comprising:
receiving a notification from the school through the communication platform; and
transmitting the notification to the plurality of electronic devices.
